(19) United States
(12) Patent Application Publication
(10) Pub. No.: US 2019/0013012 A1
(43) Pub. Date: Jan. 10, 2019

(54) SYSTEM AND METHOD FOR LEARNING SENTENCES

(71) Applicant: MINDS LAB., INC., Daejeon (KR)

(72) Inventors: Yi Gyu HWANG, Gyeonggi-do (KR); Su Lyn HONG, Seoul (KR); Tae Joon YOO, Incheon (KR)

(73) Assignee: MINDS LAB., INC., Daejeon (KR)

(21) Appl. No.: 16/027,364

(22) Filed: Jul. 4, 2018

(30) Foreign Application Priority Data
Jul. 4, 2017 (KR) 10-2017-0084852

(51) Int. Cl. G10L 15/06; G10L 15/16; G10L 25/51

(52) U.S. Cl. CPC G10L 15/063; G10L 2015/0635; G10L 25/51; G10L 15/16

(57) ABSTRACT

The present disclosure relates to a system and method of sentence learning based on an unsupervised learning method. For the same, a sentence learning method may include: enhancing a basis sentence corpus by using a word similar to a word included in a basis sentence; performing learning for the basis sentence included in the basis sentence corpus based on an unsupervised learning method; and removing an abnormal sentence among at least one similar sentence obtained by performing of the sentence learning.

### CROSS REFERENCE TO RELATED APPLICATION

The present application claims priority to Korean Patent Application No. 10-2017-0084852, filed Jul. 4, 2017, the entire contents of which is incorporated herein for all purposes by this reference.

### BACKGROUND OF THE INVENTION

### Field of the Invention

The present disclosure relates generally to a system and method of performing learning for a sentence on the basis of an unsupervised learning method.

### Description of the Related Art

In voice based artificial intelligence services, collecting samples of languages is important. In other words, improving a voice recognition rate or a recognition rate of a question, an accuracy of the response, etc. can be achieved by collecting as many language samples as possible.

Conventionally, a developer has directly input samples to collect language samples. However, collecting language samples through artificial input from an individual is limited in terms of quantitative and qualitative aspects. Accordingly, rather than depending on a personal capability, developing a method of collecting language samples by machine is required.

The foregoing is intended merely to aid in the understanding of the background of the present disclosure, and is not intended to mean that the present disclosure falls within the purview of the related art that is already known to those skilled in the art.

### SUMMARY OF THE INVENTION

An object of the present disclosure is to provide a system and method of autonomously performing learning for a sentence on the basis of an unsupervised learning method.

Another object of the present disclosure is to provide a system and method of autonomously performing filtering for an abnormal sentence among similar sentences generated from sentence learning.

Technical problems obtainable from the present disclosure are not limited by the above-mentioned technical problems, and other unmentioned technical problems may be clearly understood from the following description by those having ordinary skill in the technical field to which the present disclosure pertains.

According to one aspect of the present disclosure, in a sentence learning system, a basis sentence corpus may be enhanced by using a word similar to a word included in a basis sentence, learning may be performed for the basis sentence included in the basis sentence corpus based on an unsupervised learning method, and an abnormal sentence among at least one similar sentence obtained may be removed by performing of the sentence learning.

According to one aspect of the present disclosure, in a sentence learning system, the enhancing of the basis sentence corpus may be performed by additionally generating a basis sentence obtained by replacing the word included in the basis sentence with the similar word.

According to one aspect of the present disclosure, in a sentence learning system, the similar word may be obtained by performing word embedding based on a deep learning network (DNN).

According to one aspect of the present disclosure, in a sentence learning system, the unsupervised learning method includes a generative adversarial network (GAN).

According to one aspect of the present disclosure, in a sentence learning system, the system may further include generating, by a generator, a sentence copying the basis sentence; and determining, by discriminator, a similarity between the copied sentence and the basis sentence.

According to one aspect of the present disclosure, in a sentence learning system, the removing of the abnormal sentence may include removing at least one of a sentence identical to the basis sentence among the at least one similar sentence, and a duplicated sentence between the similar sentences.

According to one aspect of the present disclosure, in a sentence learning system, the removing of the abnormal sentence may include determining whether or not the similar sentence is an abnormal sentence by performing N-gram word analysis.

According to one aspect of the present disclosure, in a sentence learning system, the system may further include enhancing the basis sentence corpus by using the at least one similar sentence from which the abnormal sentence is removed. Herein, whether or not to perform again of the sentence learning based on the basis sentence corpus may be determined according to a number of similar sentences merged with the basis sentence corpus.

It is to be understood that the foregoing summarized features are exemplary aspects of the following detailed description of the present disclosure without limiting the scope of the present disclosure.

According to the present disclosure, there is provided a system and method of autonomously performing learning for a sentence on the basis of an unsupervised learning method.

According to the present disclosure, there is provided a system and method of autonomously performing filtering for an abnormal sentence among similar sentences generated from sentence learning.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view showing a sentence learning system according to an embodiment of the present disclosure.

FIG. 2 is a view of a flowchart showing a sentence leaning method according to the present disclosure; and

FIG. 3 is a view of a flowchart showing sentence filtering.

### DETAILED DESCRIPTION OF THE INVENTION

As embodiments allow for various changes and numerous embodiments, exemplary embodiments will be illustrated in the drawings and described in detail in the written description. However, this is not intended to limit embodiments to particular modes of practice, and it is to be appreciated that all changes, equivalents, and substitutes that do not depart from the spirit and technical scope of embodiments are encompassed in embodiments. The similar reference numerals refer to the same or similar functions in various aspects. The shapes, sizes, etc. of components in the drawings may be exaggerated to make the description clearer. In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a certain feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present disclosure is defined only by the appended claims, appropriately interpreted, along with the full range of equivalents to which the claims are entitled.

It will be understood that, although the terms including ordinal numbers such as “first”, “second”, etc. may be used herein to describe various elements, these elements are not limited by these terms. These terms are only used to distinguish one element from another. For example, a second element could be termed a first element without departing from the teachings of the present inventive concept, and similarly a first element could be also termed a second element. The term “and/or” includes any and all combination of one or more of the associated items listed.

When an element is referred to as being “connected to” or “coupled with” another element, it can not only be directly connected or coupled to the other element, but also it can be understood that intervening elements may be present. In contrast, when an element is referred to as being “directly connected to” or “directly coupled with” another element, there are no intervening elements present.

Also, components in embodiments of the present disclosure are shown as independent to illustrate different characteristic functions, and each component may be configured in a separate hardware unit or one software unit, or combination thereof.

For example, each component may be implemented by combining at least one of a communication unit for data communication, a memory storing data, and a control unit (or processor) for processing data.

Alternatively, constituting units in the embodiments of the present disclosure are illustrated independently to describe characteristic functions different from each other and thus do not indicate that each constituting unit comprises separate units of hardware or software. In other words, each constituting unit is described as such for the convenience of description; thus, at least two constituting units may from a single unit and at the same time, a single unit may provide an intended function while it is divided into multiple sub-units and an integrated embodiment of individual units and embodiments performed by sub-units all should be understood to belong to the claims of the present disclosure as long as those embodiments belong to the technical scope of the present disclosure.

Terms are used herein only to describe particular embodiments and do not intend to limit the present disclosure. Singular expressions, unless contextually otherwise defined, include plural expressions. Also, throughout the specification, it should be understood that the terms “comprise”, “have”, etc. are used herein to specify the presence of stated features, numbers, steps, operations, elements, components or combinations thereof but do not preclude the presence or addition of one or more other features, numbers, steps, operations, elements, components, or combinations thereof. That is, when a specific element is referred to as being “included”, elements other than the corresponding element are not excluded, but additional elements may be included in embodiments of the present disclosure or the scope of the present disclosure.

Furthermore, some elements may not serve as necessary elements to perform an essential function in the present disclosure, but may serve as selective elements to improve performance. The present disclosure may be embodied by including only necessary elements to implement the spirit of the present disclosure excluding elements used to improve performance, and a structure including only necessary elements excluding selective elements used to improve performance is also included in the scope of the present disclosure.

Hereinafter, embodiments of the present disclosure are described in detail with reference to the accompanying drawings. When determined to make the subject matter of the present disclosure unclear, the detailed description of known configurations or functions is omitted. To help with understanding with the disclosure, in the drawings, like reference numerals denote like parts, and the redundant description of like parts will not be repeated.

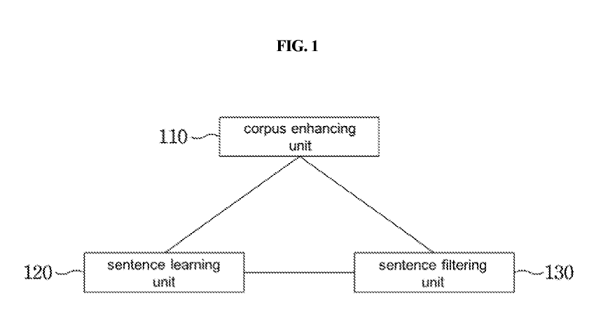

FIG. 1 is a view showing a sentence leaning system according to an embodiment of the present disclosure.

Referring to FIG. 1, a sentence leaning system according to the present disclosure may include a corpus enhancing unit 110, a sentence learning unit 120, and a sentence filtering unit 130.

A corpus means language data collected in a manner that a computer reads texts for finding out how language is used. Based on a corpus artificially generated by developer or manager or based on a pre-generated corpus, a basis sentence corpus may be generated where texts in a sentence form are collected in a manner that a computer reads the same.

The corpus enhancing unit 110 may obtain a word having a similarity of a predetermined level or greater with a word that is includes in the basis sentence corpus by performing word embedding or paraphrase, and enhance the basis sentence corpus by using the obtained word. In detail, the corpus enhancing unit 110 may generate a new sentence by replacing a word or noun which is included in a basis sentence with a synonym, and thus enhance the basis sentence corpus.

The sentence learning unit 120 may perform sentence learning on the basis of the enhanced basis sentence corpus, and generate a similar sentence according to the learning result. Herein, sentence learning may be performed on the basis of a sequence unsupervised learning method. Unsupervised learning means a method where an artificial neural network performs learning for a neural weight by using input data and without a target value by itself. By performing unsupervised learning, an artificial neural network may update neural weights by using correlations between input patterns by itself.

The sentence filtering unit 130 removes an abnormal sentence among similar sentences generated in the sentence learning unit 120. In detail, the sentence filtering unit 130 may remove a similar sentence identical to a basis sentence, a similar sentence identical to a pre-generated similar sentence, or an abnormal similar sentence by using N-gram word analysis.

The corpus enhancing unit 110 may enhance the basis sentence corpus by using similar sentences except for sentences filtered in the sentence filtering unit 130.

The sentence learning unit 120 may determine whether or not to again perform learning on the basis whether or not a number of sentences added to the basis sentence corpus is equal to or greater than a predetermined number.

Hereinafter, operation of the sentence learning system will be described in detail with reference to the drawings.

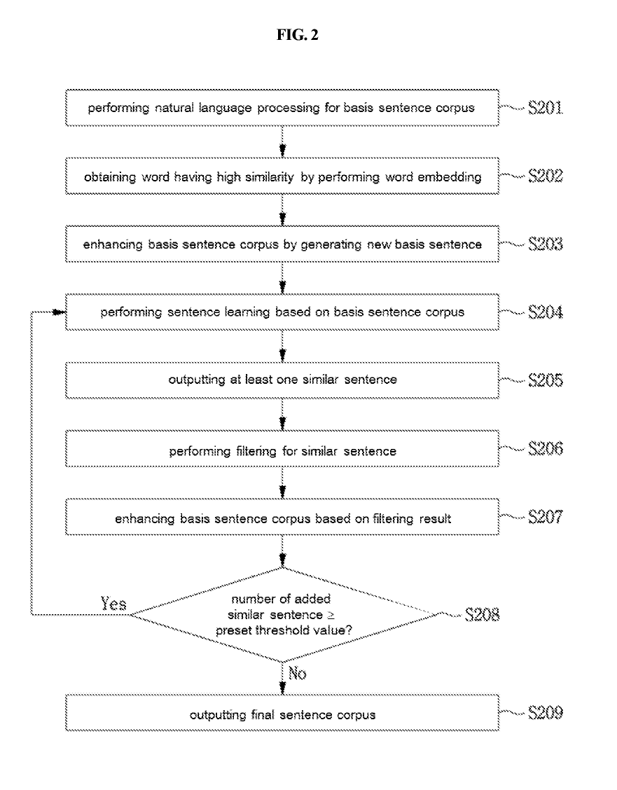

FIG. 2 is a view of a flowchart showing a sentence leaning method according to the present disclosure.

Based on at least one corpus, a basis sentence corpus may be generated. In one embodiment, the basis sentence corpus may be generated by combining at least two words included in at least one basis corpus such as corpus generated by a developer or manager, corpus pre-existing on the web, etc. Hereinafter, a sentence included in the basis sentence corpus is called a basis sentence.

In step S201, the corpus enhancing unit 110 performs language processing for basis sentences included in the basis sentence corpus. In one embodiment, the corpus enhancing unit 110 may identify a morpheme or a relation between morphemes included in the basis sentence by performing morpheme analysis or syntax analysis for the basis sentence.

Based on the result of the performed language processing, in step S202, by performing word embedding or paraphrasing, words having a similarity of a predetermined level or greater with a word constituting basis sentences may be obtained. Word embedding or paraphrasing may be performed on the basis of a database obtained by a neural network by performing learning, or may be performed by using a synonym dictionary (bags of word). Herein, a neural network may include at least one of a deep neural network (DNN), an artificial neural network (ANN), a convolutional neural network (CNN), and a recurrent neural network (RNN).

When words having a similarity of a predetermined level or greater with a word constituting basis sentences are obtained, in step S203, the corpus enhancing unit 110 may replace a word constituting the basis sentence with the obtained similar word, obtain a new basis sentence, and thus enhance the basis sentence corpus on the basis of the same. In one embodiment, when the basis sentence is configured with “A is B”, it is assumed that a noun A′ similar to the noun A and a noun B′ similar to the noun B are obtained through word embedding. Herein, the corpus enhancing unit 110 may enhance the basis sentence corpus by generating a sentence of “A′ is B”, “A is B′”, or “A′ is B′” which is obtained by replacing at least one of A and B with at least one of A′ and B′.

In step S204, the sentence learning unit 120 performs sentence leaning on the basis of the enhanced basis sentence corpus, and in step S205, according to the result of the sentence learning, the sentence learning unit 120 may generate at least one similar sentence that is similar to the basis sentence. In order to generate a similar sentence that is similar to the basis sentence, sentence leaning may be performed by using an unsupervised learning method. In one embodiment, a generative adversarial network (GAN) is an example of unsupervised learning through mutual competition between a generator and a discriminator. When an unsupervised learning method such as sequence GAN is used, a similar sentence that is predicted to be similar to the basis sentence may be generated and output. In detail, a generator may generate a sentence that copies the basis sentence, and a discriminator may select a similar sentence having a similarity of a predetermined probability or greater with the basis sentence among sentences generated in the generator, and output the same.

In step S206, the sentence filtering unit 130 may perform filtering for the similar sentence. In detail, the sentence filtering unit 130 may remove an abnormal sentence such as a duplicated sentence, a sentence that does not fit the grammar, etc. among similar sentences output from the sentence learning unit 120.

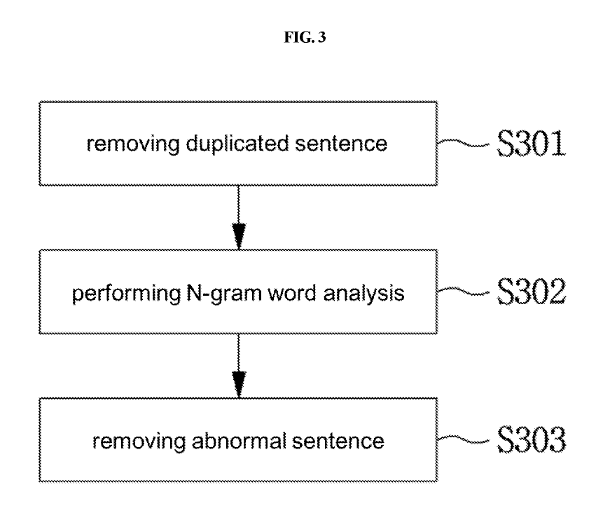

FIG. 3 is a view showing sentence filtering.

Referring to FIG. 3, in step S301, first, a duplicated sentence may be removed from similar sentences. Herein, a duplicated sentence may mean a sentence identical to the basis sentence, or a sentence identical to a pre-generated similar sentence.

Then, in step S302, N-gram analysis is performed for the generated similar sentence, and in step S303, an abnormal sentence may be removed by referencing the result of the word analysis. By performing N-gram word analysis, whether or not the generated similar sentence is an abnormal sentence may be determined. Herein, N-gram word analysis may be performed by verifying grammar for N consecutive words within the similar sentence. In one embodiment, a similar sentence including N consecutive words which are determined to be grammatically abnormal may be determined as an abnormal sentence

Grammar verifying may be performed by using an N-gram word database. The N-gram word database may be implemented according to a frequency and importance by using collected sentences where hundreds of millions of syntactic words are included. In one embodiment, grammar verifying may be performed on the basis of whether or not N consecutive words included in the similar sentence are present in the N-gram word database, or whether or not a consecutive occurrence probability of N continuous words included in the similar sentence is equal to or greater than a preset threshold value.

N may be a natural number equal to or greater than 2, and N-gram may mean bigram, trigram, or quadgram. Preferably, N-gram may be trigram.

An abnormal sentence may be artificially removed by a developer or manager. By artificially removing an abnormal sentence by a developer or manager, reliability of the generated similar sentence may increase.

In step S207, the basis sentence corpus may be enhanced by performing merging with the basis sentence corpus similar sentences remained after performing sentence filtering.

Herein, the sentence learning unit 120 may determine whether or not to again perform the leaning according to whether or not a number of similar sentences merged with the basis sentence corpus is equal to or greater than a predetermined number. In one embodiment, when a number of similar sentences merged with the basis sentence corpus is equal to or greater than a predetermined number in step S208, steps S204 to S206 of performing sentence learning and sentence filtering by using the enhanced basis sentence corpus may be performed again. Meanwhile, when a number of similar sentences merged with the basis sentence corpus is less than a predetermined number in step S208, sentence learning may not be performed, and in step S209, the enhanced basis sentence corpus may be output. Herein, a number of sentences that becomes a criterion for determining whether or not to again perform the sentence learning may be a fixed value, or may be a parameter varying according to a number of times in which sentence learning is performed. In one embodiment, as again performing of the sentence learning progresses, a number of sentences for determining whether or not to perform again the sentence learning may tend to increase or decrease.

The basis sentence corpus that is finally output may be used for various artificial intelligence (AI) services such as a voice recognition system, a question answering system, a chatter robot, etc.

All of steps shown in a flowchart described with reference to FIGS. 2 and 3 are not essential for an embodiment of the present disclosure, and thus the present disclosure may be performed by omitting several steps thereof. In one embodiment, the present disclosure may be practiced by omitting steps S202 and S203 of enhancing a basis sentence corpus by the corpus enhancing unit 110, or may be practiced by omitting step S206 of performing sentence filtering, and merging a similar sentence with the basis sentence corpus. Alternatively, sentence filtering may be performed by omitting any one of the processes of sentence filtering.

In addition, the present disclosure may also be practiced in a different order than that shown in FIGS. 2 and 3. Although the present disclosure has been described in terms of specific items such as detailed components as well as the limited embodiments and the drawings, they are only provided to help general understanding of the invention, and the present disclosure is not limited to the above embodiments. It will be appreciated by those skilled in the art that various modifications and changes may be made from the above description.

Therefore, the spirit of the present disclosure shall not be limited to the above-described embodiments, and the entire scope of the appended claims and their equivalents will fall within the scope and spirit of the invention.

What is claimed is:

1. A sentence learning method, the method comprising:
enhancing a basis sentence corpus by using a word similar to a word included in a basis sentence;
performing learning for the basis sentence included in the basis sentence corpus based on an unsupervised learning method; and
removing an abnormal sentence among at least one similar sentence obtained by performing of the sentence learning.

2. The method of claim 1, wherein the enhancing of the basis sentence corpus is performed by additionally generating a basis sentence obtained by replacing the word included in the basis sentence with the similar word.

3. The method of claim 2, wherein the similar word is obtained by performing word embedding based on a deep learning network (DNN).

4. The method of claim 1, wherein the unsupervised learning method includes a generative adversarial network (GAN).

5. The method of claim 4, wherein the performing of the sentence learning includes:
generating, by a generator, a sentence copying the basis sentence; and
determining, by discriminator, a similarity between the copied sentence and the basis sentence.

6. The method of claim 1, wherein the removing of the abnormal sentence includes removing at least one of a sentence identical to the basis sentence among the at least one similar sentence, and a duplicated sentence between the similar sentences.

7. The method of claim 1, wherein the removing of the abnormal sentence includes determining whether or not the similar sentence is an abnormal sentence by performing N-gram word analysis.

8. The method of claim 1, further comprising enhancing the basis sentence corpus by using the at least one similar sentence from which the abnormal sentence is removed, wherein whether or not to perform again of the sentence learning based on the basis sentence corpus is determined according to a number of similar sentences merged with the basis sentence corpus.

9. A sentence learning system, the system comprising:
a corpus enhancing unit enhancing a basis sentence corpus by using a word similar to a word included in a basis sentence;
a sentence learning unit performing learning for the basis sentence included in the basis sentence corpus by using an unsupervised learning method; and
a sentence filtering unit removing an abnormal sentence among the at least one similar sentence obtained by performing the sentence learning.

10. The system of claim 9, wherein the corpus enhancing unit enhances the basis sentence corpus by adding a basis sentence obtained by replacing the word included in the basis sentence with the similar word.

11. The system of claim 9, wherein the unsupervised learning method includes a generative adversarial network (GAN), and the sentence learning unit includes a generator generating a sentence copying the basis sentence, and a discriminator determining a similarity between the copied sentence and the basis sentence.

12. The system of claim 9, wherein the sentence filtering unit determines whether or not the similar sentence is an abnormal sentence by performing N-gram word analysis.

13. The system of claim 9, wherein the corpus enhancing unit enhances the basis sentence corpus by using the least one similar sentence from which the abnormal sentence is removed, and the sentence learning unit determines whether or not to perform again the sentence learning based on the basis sentence corpus according to a number of similar sentences merged with the basis sentence corpus.
